(19) United States
(12) Patent Application Publication
(10) Pub. No.: US 2025/0348987 A1
(43) Pub. Date: Nov. 13, 2025

(54) DEFECT DETECTION METHOD, DEVICE, COMPUTER EQUIPMENT, AND STORAGE MEDIUM

(71) Applicant: Jabil Inc., St. Petersburg, FL (US)

(72) Inventors: Kevin Chen, Chengdu (CN); Tusson Du, Chengdu (CN); Vivian Sun, Sarasota, FL (US); May Yap, Singapore (SG)

(73) Assignee: Jabil Inc., St. Petersburg, FL (US)

(21) Appl. No.: 19/091,209

(22) Filed: Mar. 26, 2025

(30) Foreign Application Priority Data
May 7, 2024 (CN) 202410554324.3

(51) Int. Cl. G06T 7/00; G06V 10/42; G06V 10/44; G06V 10/75; G06V 10/80

(52) U.S. Cl. CPC G06T 7/0002; G06V 10/42; G06V 10/44; G06V 10/751; G06V 10/806; G06T 2207/20081; G06T 2207/20221

(57) ABSTRACT

Provided is a defect detection method and device, computer equipment and a storage medium. The method includes: acquiring an RGB image, a depth image and a sample label of a detection object sample; performing feature map extraction and feature map fusion on the RGB image and the depth image by a feature extraction network of the defect detection model, to obtain a fused feature map; performing defect detection based on the fused feature map by a feature reconstruction network of the defect detection model, to obtain a defect score map, wherein the defect score map being obtained by fusing a global defect score map which is generated based on a global defect detection network with a local defect score map which is generated by a local defect detection network; and updating parameters of the defect detection model based on the defect score map and the sample label.

### CROSS REFERENCE TO RELATED APPLICATIONS

This application is based upon and claims priority to Chinese Patent Application No. 202410554324.3, filed on May 7, 2024, the entire contents of which are incorporated herein by reference.

### TECHNICAL FIELD

The present disclosure relates to the technical field of defect detection, and in particular to a defect detection method and device, computer equipment and storage medium.

### BACKGROUND

In the electronic manufacturing industry, the requirements for the quality of component mounting and welding has increased with the trend of miniaturization, precision and multi-functionality of electronic products. As a key link in quality management, defect detection usually refers to identifying and locating problems that do not meet predetermined standards or specifications in products, materials, components or systems by automated or manual methods.

In the related art, defect detection methods include 2D and 3D defect detection algorithms. 2D automatic optical inspection (AOI) equipment takes pictures at different angles and positions, and a 2D image processing algorithm is relied on to achieve defect detection. The 3D defect detection algorithm originates from 2D defect detection algorithm, while point cloud or depth map inputs are added to data set diagrams of the 2D algorithm, so that stereoscopic analysis can be performed on objects to be detected to achieve defect detection.

However, 2D AOI equipment and the defect detection algorithm thereof have inherent limitations, it is difficult for a 2D vision system to detect 3D defects; while the defect detection capability of the existing 3D defect detection algorithm, which can support defect detection with depth information, is also limited, resulting in poor defect detection performance.

### SUMMARY

Embodiments of the present disclosure provide a defect detection method and device, computer equipment and storage medium.

In a first aspect, provided is a defect detection method, the method includes: an RGB image of a detection object sample, a depth image of the detection object sample, and a sample label of the detection object sample are acquired. A feature extraction network of a defect detection model performs feature map extraction and feature map fusion on the RGB image and the depth image of the detection object sample, so as to obtain a fused feature map. A feature reconstruction network of the defect detection model performs defect detection based on the fused feature map, so as to obtain a defect score map of the detection object sample; wherein the feature reconstruction network includes a global defect detection network and a local defect detection network, the global defect detection network is used to generate a global defect score map based on the fused feature map from a global perspective, and the local defect detection network is used to generate a local defect score map based on the fused feature map from a local perspective; and the defect score map is obtained by fusing the global defect score map with the local defect score map. Parameters of the defect detection model are updated based on the defect score map of the detection object sample and the sample label of the detection object sample. A trained defect detection model is used for performing defect detection on a to-be-detected object according to an RGB image and a depth image of the to-be-detected object.

In another aspect, provided is a defect detection device, the device includes: an acquiring module, configured to acquire an RGB image of a detection object sample, a depth image of a detection object sample, and a sample label of the detection object sample; a feature map generation module, configured to perform feature map extraction and feature map fusion on the RGB image and the depth image of the detection object sample by means of a feature extraction network of the defect detection model, so as to obtain a fused feature map; a defect detection module, configured to perform defect detection based on the fused feature map by means of a feature reconstruction network of the defect detection model, so as to obtain a defect score map of the detection object sample, wherein the feature reconstruction network comprises a global defect detection network and a local defect detection network, the global defect detection network is used to generate a global defect score map based on the fused feature map from a global perspective, the local defect detection network is used to generate a local defect score map based on the fused feature map from a local perspective, and the defect score map is obtained by fusing the global defect score map with the local defect score map; and a model training module configured to update parameters of the defect detection model based on the defect score map of the detection object sample and the sample label of the detection object sample. Where a trained defect detection model is used for performing defect detection on a to-be-detected object according to an RGB image and a depth image of a to-be-detected object.

In one possible implementation, the detection object sample is a normal object sample or a defective object sample; upon the condition that the detection object sample is a defective object sample, the sample label of the detection object sample includes a defect area annotation; and the defect detection module includes: a mask-processing submodule for masking a defect fusion feature in the fused feature map based on the defect area annotation; and a defect detection submodule for performing defect detection based on a masked fused feature map by a feature reconstruction network of the defect detection model, so as to obtain a defect score map of the detection object sample.

In one possible implementation, the defect detection module includes: a first processing submodule for performing compression, decompression, and calculation of anomaly score on the fused feature map by the global defect detection network, so as to obtain the global defect score map; a second processing submodule for performing compression, decompression, and calculation of anomaly score on the fused feature map by the local defect detection network, so as to obtain defect scores corresponding to pixel features; a reorganizing submodule for reorganizing defect scores corresponding to the pixel features based on position coordinates corresponding to the pixel features, so as to obtain the local defect score map; and a first fusion submodule for fusing the global defect score map with the local defect score map, so as to obtain the defect score map of the detection object sample.

In one possible implementation, the first fusion submodule includes: a normalization unit for normalizing the global defect score map and the local defect score map pixel by pixel respectively, so as to obtain a normalized global defect score map and a normalized local defect score map; and a fusion unit for performing weighted fusing on the normalized global defect score map and the normalized local defect score map, so as to obtain the defect score map of the detection object sample.

In one possible implementation, the model training module is used to: upon the condition that the detection object sample is a normal object sample, update parameters of the defect detection model based on an image type indicated by the defect score map of the detection object sample and an image type indicated by the sample label of the detection object sample; or upon the condition that the detection object sample is a defective object sample, update parameters of the defect detection model based on a predicted defect area indicated by the defect score map of the detection object sample and a defect area indicated by the sample label of the detection object sample.

In one possible implementation, the defect detection module includes a feature classification network; and the device further includes a feature classification module for performing feature classification based on the fused feature map of the detection object sample by the feature classification network in the defect detection model, so as to obtain a classified score map of the detection object sample; each score in the classified score map is used to indicate the probability that a corresponding pixel point is defective. The model training module includes: a second fusion submodule for performing weighted fusing on a defect score map of the detection object sample and the classified score map pixel by pixel respectively, so as to obtain a comprehensive defect score map of the detection object sample; and a parameter updating submodule for updating parameters of the defect detection model based on the comprehensive defect score map of the detection object sample, the defect score map of the detection object sample, the classified score map of the detection object sample, and the sample label of the detection object sample.

In one possible implementation, the parameter updating submodule includes: a first calculation unit for calculating a function value of a first loss function based on the comprehensive defect score map of the detection object sample and a sample label of the detection object sample; a second calculation unit for calculating a function value of a second loss function based on the defect score map of the detection object sample and the sample label of the detection object sample; a third calculation unit for calculating a function value of a third loss function based on the classified score map of the detection object sample and a sample label of the detection object sample; and a parameter updating unit for updating parameters of the defect detection model based on the function value of the first loss function, the function value of the second loss function, and the function value of the third loss function.

In one possible implementation, the parameter updating unit is used to: upon the condition that the detection object sample is a normal object sample, calculate a total loss function value based on the function value of the first loss function and the function value of the second loss function, and update parameters of the feature reconstruction network in the defect detection model based on the total loss function value; or, upon the condition that the detection object sample is a defective object sample, calculate a total loss function value based on the function value of the first loss function, the function value of the second loss function and the function value of the third loss function, and update parameters of the feature reconstruction network and the feature classification network in the defect detection model based on the total loss function value.

In one possible implementation, the feature extraction network includes a first feature extraction layer, a second feature extraction layer and a feature fusion layer. The feature map generation module includes: a first extraction submodule for performing feature map extraction on the RGB image of the detection object sample by the first feature extraction layer, so as to obtain a corresponding RGB feature map; a second extraction submodule for performing feature map extraction on a depth image of the detection object sample by the second feature extraction layer, so as to obtain a corresponding depth feature map; and a feature fusion submodule for performing feature fusion on the RGB feature map and the depth feature map by the feature fusion layer, so as to obtain the fused feature map.

In another aspect, provided is computer equipment, the computer equipment includes a processor and a memory, the memory stores at least one computer program, and the at least one computer program is loaded and executed by the processor to implement the defect detection method described above.

In another aspect, provided is a non-transitory computer-readable storage medium, the computer-readable storage medium stores at least one computer program, and the computer program is loaded and executed by a processor to implement the defect detection method described above.

In another aspect, provided is a computer program product, the computer program product includes at least one computer program, and the computer program is loaded and executed by a processor to implement the defect detection method provided in various implementations described above.

### BRIEF DESCRIPTION OF DRAWINGS

The accompanying drawings are incorporated herein and constitute a part of the specification, which illustrate embodiments in accordance with the present disclosure, and are used together with the specification to explain the principles of the present disclosure.

FIG. 1 illustrates a flow chart of a defect detection method provided in an exemplary embodiment of the present disclosure.

FIG. 2 illustrates a flow chart of a defect detection method provided in an exemplary embodiment of the present disclosure.

FIG. 3 illustrates a structural schematic diagram of a feature fusion layer provided by an exemplary embodiment of the present disclosure.

FIG. 4 illustrates a schematic flow chart of masking a fused feature map provided by an exemplary embodiment of the present disclosure.

FIG. 5 illustrates a flow chart of a defect detection method provided in an exemplary embodiment of the present disclosure.

FIG. 6 illustrates a structural schematic diagram of a defect detection model provided in an exemplary embodiment of the present disclosure.

FIG. 7 illustrates a block diagram of a defect detection device provided in an exemplary embodiment of the present disclosure.

FIG. 8 is a structural block diagram of a computer equipment provided in an exemplary embodiment of the present disclosure.

FIG. 9 is a structural block diagram of a computer equipment provided in an exemplary embodiment of the present disclosure.

### DETAILED DESCRIPTION

Exemplary embodiments will be described in detail herein, examples of which are illustrated in the accompanying drawings. When the following description refers to the accompanying drawings, the same reference numbers in different figures indicate the same or similar elements unless otherwise indicated. The implementations described in the following exemplary embodiments do not represent all of the implementations in accordance with the present disclosure. Instead, they are merely examples of devices and methods in accordance with aspects of this disclosure as detailed in the appended claims.

It should be understood that the term “several” means one or more and the term “a plurality of” means two or more than two as mentioned herein. The term “and/or” describes the association of associated objects, indicating that there can be three relationships, for example, A and/or B may include the following three situations: A alone, A and B together, B alone. The character “/” generally indicates that the objects associated therewith before and after are in an “or” relationship.

Firstly, the terms involved in the present disclosure are explained below:

### 1) Defect and Normality

Defect, also known as anomaly/flaw, NG (Not Good), can be referred to as foreground (defect target foreground) in an image of a defect detection task; on the contrary, normality, Good/OK, is referred to as background (non-defect) in an image of a defect detection task.

### 2) Image Defect Detection Algorithm

Image defect detection, also known as anomaly detection or flaw detection; for anomalies (such as scratches, leakage, and unevenness) in an industrial production process, an image algorithm method is used to perform defect detection, which mainly achieves defect classification (determining whether it is OK or NG classification), positioning of defect location (finding the coordinate position in the image), and defect segmentation (segmenting a detailed outer contour).

### 3) Depth Map

In 3D (three-dimensional) computer graphics, a depth map is an image or image channel that contains information related to a distance to the surface of a scene object from the viewpoint. A depth map is similar to a grayscale image, but each pixel value of a depth map is an actual distance from a sensor to an object. Usually an RGB image and a depth image are registered, there is a one-to-one correspondence between pixels. The RGB image reflects appearance information such as color, shape, boundary, texture, etc., of a scene, whereas the depth image depicts depth-of-field difference and structural information among different objects.

Embodiments of the present disclosure provide a defect detection method, which can combine global anomaly detection and local anomaly detection to train a defect detection model, thereby improving defect detection capability of the defect detection model, such that when the defect detection model is used to perform defect detection, large defects as well as small defects in a to-be-detected object can be detected, thereby improving the comprehensiveness and accuracy of defect detection.

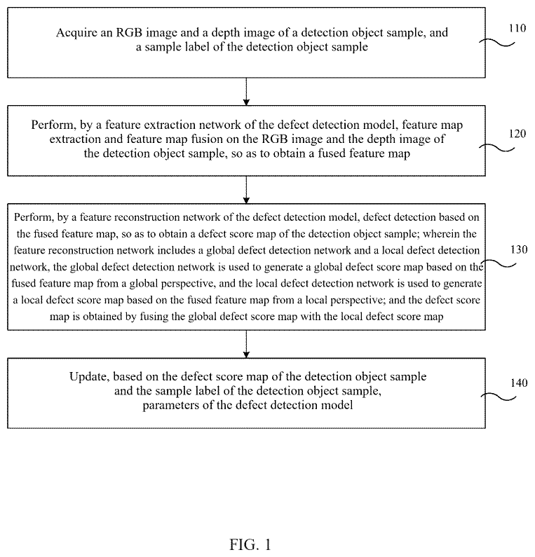

FIG. 1 illustrates a flow chart of a defect detection method provided in an exemplary embodiment of the present disclosure, the method may be performed by a computer equipment, which may be implemented as a server or a terminal, as shown in FIG. 1, the defect detection algorithm may include the following steps S110 to S140.

At step 110, an RGB image and a depth image of a detection object sample, and a sample label of the detection object sample are acquired.

The sample label of the detection object sample may be used to indicate whether the detection object sample is a defective object sample or a normal object sample; the detection object sample may be any sample in a training sample set, and the training sample set may include normal object samples and defective object samples, wherein an image corresponding to a normal object sample may be referred to as an OK image, and an image corresponding to a defective object sample may be referred to as an NG image.

At step 120, a feature extraction network of the defect detection model performs feature map extraction and feature map fusion are performed on the RGB image and the depth image of the detection object sample, so as to obtain a fused feature map.

The feature extraction network may include different feature extractors corresponding to RGB images and depth images, when feature extraction is performed, feature maps can be extracted by corresponding feature extractors, after feature maps corresponding to RGB images and feature maps corresponding to depth images are acquired, these two types of feature maps are fused by a feature map fusion device in the feature extraction network, so as to obtain the fused feature map.

The feature extraction network of the defect detection model may be pre-trained, and during training of the defect detection model, parameters in the feature extraction network may not be tuned, or may be fine-tuned.

At step 130, a feature reconstruction network of the defect detection model performs defect detection based on the fused feature map, so as to obtain a defect score map of the detection object sample; the feature reconstruction network includes a global defect detection network and a local defect detection network, the global defect detection network is used to generate a global defect score map based on the fused feature map from a global perspective, and the local defect detection network is used to generate a local defect score map based on the fused feature map from a local perspective; the defect score map is obtained by fusing the global defect score map with the local defect score map.

During training of the feature reconstruction network, fused features input into the feature reconstruction network are usually fused features that characterize normal-area images, the purpose of training is to make a reconstructed image generated by the feature reconstruction network similar to a normal-area image in the input original image as possible, that is, to reduce the error between the reconstructed image and the normal-area image in the original image; during use, whether a corresponding to-be-detected object is a normal object or a defective object can be determined based on the reconstruction error between the reconstructed image and the normal-area image of the original image, wherein the reconstruction error between a reconstructed image of a normal object and an original image tends to be relatively small, and the reconstruction error between a reconstructed image of a defective object and an original image tends to be relatively large.

In embodiments of the present disclosure, the defect score map is used to indicate the degree of difference between a reconstructed image generated by a feature reconstruction network and an original image, and the score value corresponding to each pixel in the defect score map is the probability value that a pixel is abnormal; computer equipment may implement global defect detection and local defect detection by means of AutoEncoder (automatic encoder); for global defect detection, the AutoEncoder corresponding to global defect detection is responsible for performing compression and decompression based on the whole fused feature map, so as to obtain a global reconstructed map, which may be further used together with the global defect score map; for local defect detection, the AutoEncoder corresponding to local defect detection can perform feature reconstruction on each pixel of the original image based on the input fused feature map, so as to obtain the local defect score map.

Then, the global defect score map is fused with the local defect score map, so that th defect score map that contains both defect detection information from a global perspective and defect detection information from a local perspective can be obtained.

At step 140, parameters of the defect detection model are updated based on the defect score map of the detection object sample and the sample label of the detection object sample; wherein a trained defect detection model is used for performing defect detection on a to-be-detected object based on an RGB image and an depth image of the to-be-detected object.

In embodiments of the present disclosure, computer equipment may fine-tune the feature extraction network in the defect detection model based on the defect score map of the detection object sample and the sample label of the detection object sample, and update parameters of the feature reconstruction network; alternatively, a computer equipment can keep the parameters in the feature extraction network constant, and update parameters of the feature reconstruction network.

When the trained defect detection model is applied, computer equipment may input an RGB image and a depth image of a to-be-detected object into the defect detection model, extract feature maps from the RGB image and the depth image respectively, fuse the extracted feature maps to obtain a fused feature map, obtain a corresponding defect score map after the fused feature map is processed by the feature reconstruction network, and determine the defect score map comprehensively based on the fused feature map from both a global perspective and a local perspective, so as to determine whether the to-be-detected object has defects based on the defect score map.

In summary, according to the defect detection method provided in embodiments of the present disclosure, when a defect detection model is trained, feature map extraction and feature map fusion are performed based on an RGB image and a depth image of a detection object sample to obtain a fused feature map, then a global defect score map and a local defect score map are generated based on the fused feature map respectively by a global defect detection network in a feature reconstruction network from a global perspective and a local defect detection network in the feature reconstruction network from a local perspective and, so as to fuse the two defect score maps to obtain a defect score map, then defect detection is performed on the defect detection model based on the defect score map and a sample label of the detection object sample; by means of the above-mentioned method, the defect detection model can learn global anomaly detection capability and local anomaly detection capability during the model training process, such that when the defect detection model is applied to defect detection, defect detection can be performed from both global perspective and local perspective, thereby improving the comprehensiveness and accuracy of defect detection.

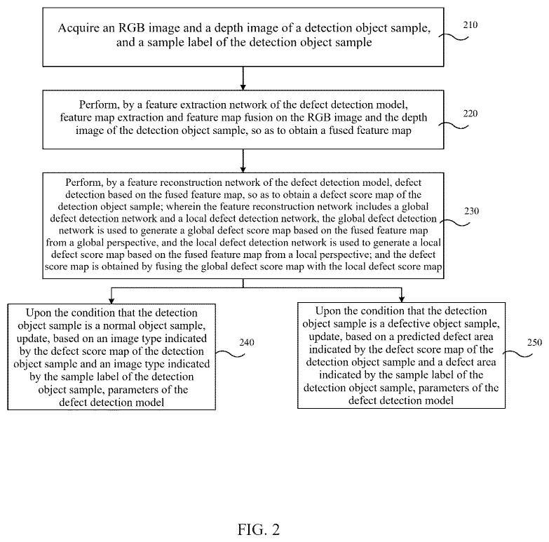

In embodiments of the present disclosure, the defect detection model includes a feature extraction network and a feature reconstruction network; the computer equipment may train the defect detection model based on a defect score map output by the feature reconstruction network, FIG. 2 illustrates a flow chart of a defect detection method provided in an exemplary embodiment of the present disclosure, the method may be performed by a computer equipment, which may be implemented as a server or a terminal, as shown in FIG. 2, the defect detection algorithm may include the following steps:

At step 210, an RGB image and a depth image of a detection object sample, and a sample label of the detection object sample are acquired.

Since the detection sample object is any object of a training sample set, and the training sample set contains normal object samples and defective object samples, the detection object sample may be a normal object sample or a defective object sample; where the detection object sample is a normal object sample, the sample label of the detection object sample may indicate that the detection object sample is a normal object sample; where the detection object sample is a defective object sample, the sample label of the detection object sample may indicate that the detection object sample is a defective object sample, in addition, the sample label of the detection object sample may further include defective area annotation.

At step 220, the feature extraction network of the defect detection model performs feature map extraction and feature map fusion on the RGB image and the depth image of the detection object sample, so as to obtain a fused feature map.

The feature extraction network includes a first feature extraction layer, a second feature extraction layer and a feature fusion layer; the process that the feature extraction network performs feature map extraction and feature map fusion may be implemented as follows:

The first feature extraction layer performs feature map extraction on the RGB image of the detection object sample, so as to obtain a corresponding RGB feature map.

The second feature extraction layer performs feature map extraction on the depth image of the detection object sample, so as to obtain a corresponding depth feature map.

And the feature fusion layer performs feature fusion on the RGB feature map and the depth feature map, so as to obtain the fused feature map.

Exemplarily, the input size of the input RGB image and the input image is 4M*4N*3, wherein M and N are positive integers; the first feature extraction layer performs feature map extraction on the RGB image, and the second feature extraction layer performs feature map extraction on the depth image, so as to obtain high-level feature representations of different pyramid levels M*N, M/2*N/2, M/4*N/4, and M/8*N/8. It should be noted that the number of levels of feature representation is determined based on network design, and the above-mentioned number of levels is illustrative and not compose limitation in in the present disclosure.

For the first feature extraction layer, an existing pre-trained feature extractor that performs feature map extraction based on a RGB image can be used; for the second feature extraction layer, due to lack of a pre-trained model based on deep images in the specific industry, computer equipment may pre-train a feature extractor adapted to deep images, during this process, the computer equipment may obtain an image set containing deep image samples, each deep image sample has a corresponding sample type label which is used to indicate whether the corresponding deep image sample is an OK image or an NG image, classified training is performed on a feature extractor of a depth image channel, predicted types include OK and NG, and training is performed on the feature extractor based on the predicted types and sample type labels. The cross-entropy loss function that can characterize classification loss can be used as a loss function, after the function value of the cross-entropy loss function converges, the classification effect of the depth image channel is determined to meet the requirements, and training of the feature extractor of the depth image channel is completed; and the network for feature extraction in the feature extractor is configured into the defect detection model as the second feature extraction layer.

The feature extractor of the depth image channel is pretrained, which can make the feature extractor adapted to depth images converge in advance, so as to avoid the situation where the data distribution is too divergent and the parameter optimization and iteration is insufficient due to the fact that a plurality of networks are trained simultaneously during training of the defect detection model, thereby improving the convergence speed of model training and reducing the difficulty of training.

In some scenarios where the demand for depth image information is not high, for example, a scenario where depth image information is used as auxiliary, or a scenario where the extraction effect of a depth feature map needs to be sacrificed due to time reasons, the computer equipment can share the parameters of the feature extraction layer corresponding to the RGB channel (i.e., the first feature extraction layer) and the feature extraction layer corresponding to the depth image channel (i.e., the second feature extraction layer), that is, the two feature extraction layers use the same weight to share a network.

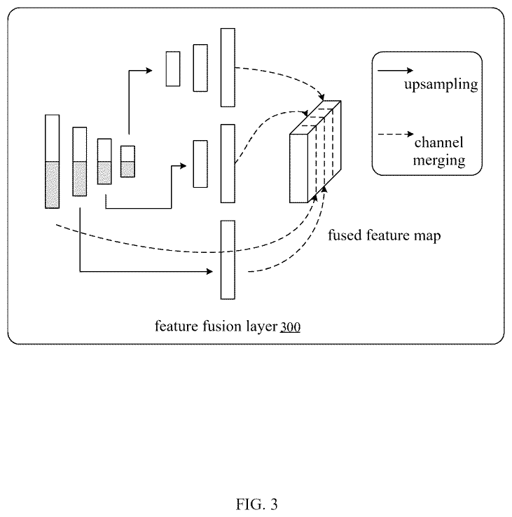

The feature fusion layer is intended to obtain a feature set with low-level semantics and high-level semantics of the same size, which is referred to as a fused feature map; FIG. 3 illustrates a structural schematic diagram of the feature fusion layer provided by an exemplary embodiment of the present disclosure, as shown in FIG. 3, due to the limitation that the RGB feature map is a feature map obtained by the first feature extraction layer, which has the capability of representing color/texture/edge features of RGB, and the depth feature map is obtained by the first feature extraction layer, which has the capability of representing depth features, the two feature maps are independent of each other in terms of features, in order to facilitate subsequent feature classification and feature reconstruction and to achieve mutual complementation of the two features, after receiving the RGB feature map and the depth feature map, the feature fusion layer 300 uses a layer-wise method to perform hierarchical superposition of each feature layer for a plurality of different pyramid level features, that is, the RGB features and depth features of each layer are feature-spliced, and then they are unified as feature maps of size (M, N), and feature upsampling is performed on feature maps of different levels, and channel merge is performed on the (M, N) feature maps obtained from each feature layer, that is, feature fusion, so as to obtain an M*N*C fused feature map with C channels. Wherein the fused feature map of the defect object sample is composed of normal fused features and defect fusion features.

At step 230, a feature reconstruction network of the defect detection model performs defect detection based on the fused feature map, so as to obtain a defect score map of the detection object sample; the feature reconstruction network includes a global defect detection network and a local defect detection network, the global defect detection network is used to generate a global defect score map based on the fused feature map from a global perspective, and the local defect detection network is used to generate a local defect score map based on the fused feature map from a local perspective; the defect score map is obtained by fusing the global defect score map and the local defect score map.

When the feature reconstruction network is trained, the capability of reconstructing a normal image by the feature reconstruction network needs to be trained, on such basis, the fused features input to the feature reconstruction network do not contain features indicating abnormal areas, therefore, where the detection object sample is a normal object sample, corresponding fused features thereof may be input into the feature reconstruction network directly; where the detection object sample is a defective object sample, the features corresponding to the defective area in the fused feature map (i.e., defect fusion features) may be determined based on the defect area annotation, and the fused feature map with masked defect fusion features corresponding to defective areas is input into the feature reconstruction network. The above process can be implemented as follows:

Based on the defect area annotation, a defect fusion feature is masked in the fused feature map.

And the feature reconstruction network of the defect detection model performs defect detection based on masked fused feature map, so as to obtain the defect score map of the detection object sample.

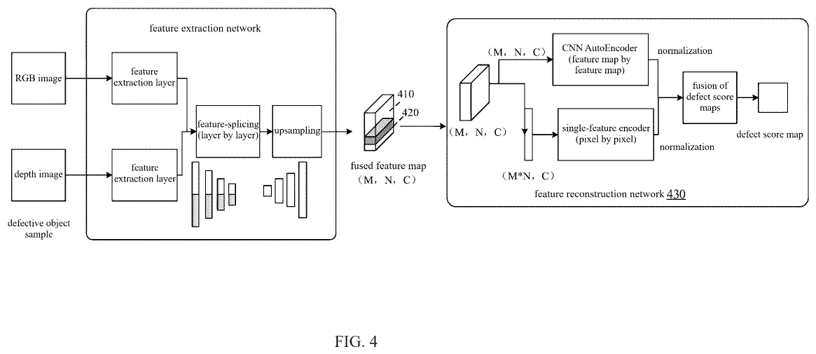

FIG. 4 illustrates a schematic flow chart of masking a fused feature map provided by an exemplary embodiment of the present disclosure, as shown in FIG. 4, the fused feature map is a fused feature map corresponding to a defective object sample, and the fused feature map contains normal fusion features 410 and defect fusion features 420, before the fused feature map is input into the feature reconstruction network 430, the defect fusion features 420 in the fused feature map are firstly masked so that the fused feature map input into the feature reconstruction network 430 contains only normal fused features.

In practical application, where the detected object sample is a normal object sample, parameters of the feature reconstruction network may be updated; optionally, where the detected object sample is a defective object sample, the subsequent process of updating parameters of the feature reconstruction network is based on the fused feature map after masking.

The process that the feature reconstruction network performs defect detection, so as to obtain the defect score map of the detection object sample can be implemented as:

The global defect detection network performs compression, decompression, and calculation of anomaly score on the fused feature map, so as to obtain the global defect score map.

The local defect detection network performs compression, decompression, and calculation of anomaly score on the fused feature map, so as to obtain defect scores corresponding to pixel features.

The defect scores corresponding to the pixel feature are reorganized based on position coordinates corresponding to pixel features to obtain a local defect score map.

And, the global defect score map is fused with the local defect score map, so as to obtain a defect score map of the detection object sample.

For the global defect detection network, from the perspective of the entire fused feature map, the fused feature map of (M, N, C) is used as input, the size of a single image is (M, N), and the number of channels is C, the image-level CNN AutoEncoder performs image-level feature reconstruction based on the fused feature map, so as to obtain a global reconstructed image of size (M, N), the reconstruction error of each pixel is obtained by comparing the global reconstructed image with the original image (i.e., the input image), the reconstruction errors of each pixel are mapped to an abnormal scoring scale to obtain a global defect score map; the higher the score value, the greater the possibility of abnormal in this part; the CNN AutoEncoder is responsible for compressing and decompressing the extracted features, such that the original image can be reconstructed by learning the intrinsic structure of the data; the deep semantic features in the image can be identified through convolutional layers and pooling layers, such that the network has a large receptive field and imparts the network sufficient detection capability for global defects.

For the local defect detection network, from the local perspective of a single feature pixel, a single feature in the fused feature map is used as input, with an input dimension of (1, C) and a number of M*N features; the network structure is a pixel-level fully connected FC AutoEncoder network detection, and the network is 1*1conv convolution inside, this network is known as FC AutoEncoder network, and the output is (1,) feature point, which represents the defect score of each fused feature point and is used to characterize the probability of anomaly present in that feature point. FC AutoEncoder inference is performed on the M*N (1, C)-dimensional features in sequence, and M*N (1,)-dimensional feature points are output. After the M*N feature points are processed by the network, they are reorganized in coordinate order to obtain a reconstructed abnormal score map of size (M, N), that is, a local defect score map, its overall effect is similar to the effect of multi-layer fully connected feature reconstruction on the feature map. For each (1, C) fused feature, it is equivalent to feature reconstruction on each pixel of the input original image. Since it is pixelwise input, FC AutoEncoder is also of 1*1conv type, which imparts the feature reconstruction network the capability to detect local anomalies from the local perspective of a single feature pixel.

In one possible implementation, the process of fusing the global defect score map with the local defect score map, so as to obtain the defect score map of the detection object sample can be implemented as follows:

The global defect score map and the local defect score map are normalized pixel by pixel respectively, to obtain a normalized global defect score map and a normalized local defect score map.

And weighted fusing is performed on the normalized global defect score map and the normalized local defect score map to obtain the defect score map of the detection object sample.

In the feature reconstruction network, the pixel-level autoencoder obtains the local feature anomaly map (fmap_l), and the image-level autoencoder obtains the global feature anomaly map (fmap_g), since the feature domains of the two are distributed differently, they need to be normalized to the similar numerical scale before fusing, and thus, a defect score map is obtained, and defect detection of images with different feature domain distributions can be adapted to.

Taking fmap_m as an example to represent the defect score map, the process of obtaining the defect score map by weighted fusing performed on the normalized global defect score map fmap_g_norm and the normalized local defect score map fmap_l_norm can be expressed as:

$$fmap\_m = α * fmap\_g \_norm + ( 1 - α ) * fmap\_l \_norm$$

Wherein α is the weight coefficient, which can be set based on actual needs.

Optionally, when the global defect score map and the local defect score map are normalized, a quantile normalization method may be used for normalization, the process may be implemented as follows:

For each score map, two p-quantiles are calculated, which denoted as qa and qb for p=a and p=b respectively:

$$qa = Quantile ( fmap , 0.9 ) \\ qb = Quantile ( fmap , 0.995 )$$

Wherein Quantile ( ) is the quantile statistics function; fmap represents fmap_g or fmap_l;

The global defect score map and the local defect score map have their own corresponding weights, and the sum of the two weights is 1, exemplarily, if the weight of the global weighted score map is a, the weight of the local defect score map is (1-a). The quantiles in the two score maps can be selected from statistical experiments, by way of example, qa uses the 90% quantile and qb uses the 99.5% quantile, based on different statistical results, the selection of quantiles can also be different, which is not limited in the present disclosure.

Meanwhile, by means of a linear transformation, qa and qb are mapped to corresponding anomaly scores, by way of example, since the defect score map is applicable to a color scale of 0 to 1, qa can be mapped to an anomaly score of 0 and qb can be mapped to a score of 0.1.

The normalized defect score graph is shown as follows:

$$fmap\_norm = \frac{m * ( fmap\_qa ) + n * ( fmap\_qb )}{qb - qa}$$

wherein m=0.1, n=0, that is:

$$fmap\_norm = \frac{0.1 * ( fmap - qa )}{qb - qa}$$

Through the above equation, the normalized global defect score map/local defect score map fmap_g_norm and fmap_l_norm may be obtained.

In one possible implementation, when weighted fusing is performed on the normalized global defect score map and the normalized local defect score map, an adaptive weight parameter a is set in the feature reconstruction network, and the adaptive weight parameter a is automatically generated by the weight adaptive regulator according to the number of current training epochs, so that the feature reconstruction network focuses on learning global anomalies in the early stage, and when sufficient global anomaly detection capability is learned in the early stage, it focuses on learning local anomaly detection capability in the later stage of training. The weight adaptive regulator can adjust the learning degree of detection capability of the two branches based on a certain function formula, and the function formula may include a cosine attenuation function, a parabola attenuation function, a linear attenuation function, and the like. By way of example, it is assumed that the total training epochs is Tmax and the current training epoch is T. The weight adaptive regulator can be composed of one of the following 3 attenuation functions:

### 1) Probability Decay Function:

$$α = 1 - {( \frac{T - 1}{{T}_{max}} )}^{2}$$

### 2) Cosine Decay Function:

$$α = cos ( \frac{π}{2} * \frac{T - 1}{{T}_{max}} )$$

### 3) Linear Decay Function:

$$α = 1 - \frac{T - 1}{{T}_{max}}$$

The attenuation function used by the weight adaptive regulator can be determined based on actual needs, which is not limited in the present disclosure.

In another possible implementation, the skilled person can customize the weights corresponding to the global defect score map and the local defect score map based on actual needs, for example, both weights can be set to 0.5, so that global defect detection is equally important as local defect detection, etc.

At step 240, upon the condition that the detection object sample is a normal object sample, parameters of the defect detection model are updated based on an image type indicated by a defect score map of the detection object sample and an image type indicated by a sample label of the detection object sample.

That is, where the detection object sample is a normal object sample, the computer equipment may determine whether the image type indicated by the defect score map of the detection object is consistent with the image type indicated by the sample label of the detection object sample; where the two image types are inconsistent, parameter updating is performed on the defect detection model so as to make the image type determined based on the defect score map and the image type indicated by the sample label as consistent as possible; when determining the image type based on the defect score map, the computer equipment can perform defect determination based on a set score threshold, where there is a pixel in the defect score map with a defect score greater than the score threshold, the pixel is determined to be defective, and the image type of the detection object sample is correspondingly determined as a defective image; Where the defect scores of all pixels in the defect score map are lower than the score threshold, it indicates that the image type of the detection object sample is a normal image, and the score threshold can be a parameter set based on actual needs.

Alternatively, at step 250, upon the condition that the detection object sample is a defective object sample, parameters of the defect detection model are updated based on a predicted defect area indicated by a defect score map of the detection object sample and a defect area indicated by a sample label of the detection object sample.

Where the detection object sample is a defective object sample, the computer equipment can calculate a loss function based on the difference between the predicted defect area indicated by the defect score map of the detection object sample and the defect area indicated by the sample label of the detection object sample, so as to perform parameter updating on the defect detection model according to the function value of the loss function, such that the image type determined based on the defect score map is as consistent as possible with the image type indicated by the sample label, meanwhile, the predicted defect area determined based on the defect score map is as consistent as possible with the defect area indicated by the sample label.

The trained defect detection model is used for performing defect detection on the to-be-detected object based on the RGB image and the depth image of the to-be-detected object.

In summary, according to the defect detection method provided in embodiments of the present disclosure, when a defect detection model is trained, feature map extraction and feature map fusion are performed based on an RGB image and a depth image of a detection object sample to obtain a fused feature map, then a global defect score map and a local defect score map are generated based on the fused feature map respectively by a global defect detection network in a feature reconstruction network from a global perspective and a local defect detection network in the feature reconstruction network from a local perspective and, so as to fuse the two defect score maps to obtain a defect score map, then defect detection is performed on the defect detection model based on the defect score map and a sample label of the detection object sample; by means of the above-mentioned method, the defect detection model can learn global anomaly detection capability and local anomaly detection capability during the model training process, such that when the defect detection model is applied to defect detection, defect detection can be performed from both global perspective and local perspective, thereby improving the comprehensiveness and accuracy of defect detection.

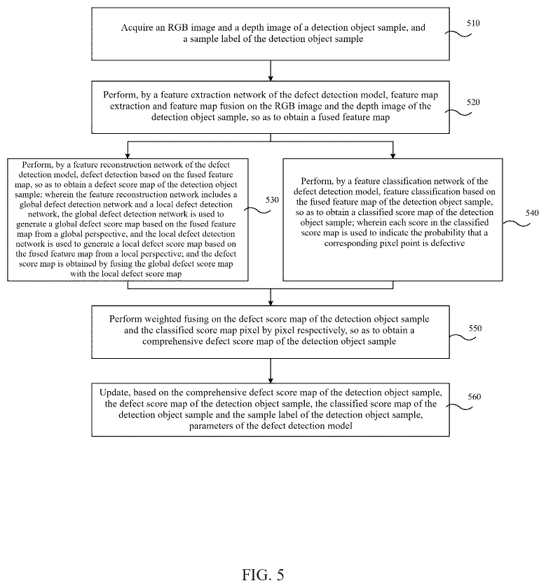

Furthermore, the defect detection model may further include a feature classification network; the feature classification network may classify pixel points pixel by pixel based on the fused feature map, so as to determine the probability that each pixel point is defective, in this case, the defect detection model may comprehensively perform defect determination based on the defect score map output by the feature reconstruction network and the classified score map output by the feature classification network; on this basis, FIG. 5 illustrates a flow chart of a defect detection method provided in an exemplary embodiment of the present disclosure, the method may be performed by a computer equipment, which may be implemented as a server or a terminal, as shown in FIG. 5, the defect detection algorithm may include the following steps:

At step 510, an RGB image and a depth image of a detection object sample, and a sample label of the detection object sample are acquired.

At step 520, a feature extraction network of the defect detection model performs feature map extraction and feature map fusion are performed on the RGB image and the depth image of the detection object sample, to obtain a fused feature map.

At step 530, a feature reconstruction network of the defect detection model performs defect detection based on the fused feature map, to obtain a defect score map of the detection object sample; the feature reconstruction network includes a global defect detection network and a local defect detection network, the global defect detection network is used to generate a global defect score map based on the fused feature map from a global perspective, and the local defect detection network is used to generate a local defect score map based on the fused feature map from a local perspective; the defect score map is obtained by fusing the global defect score map with the local defect score map.

For the relevant contents of step 510 to step 530, reference may be made to the relevant contents of the embodiment shown in FIG. 1 or FIG. 2, and will not be repeated here.

At step 540, feature classification is performed based on a fused feature map of the detection object sample through the feature classification network in the defect detection model to obtain a classified score map of the detection object sample; each score in the classified score map is used to indicate the probability that a corresponding pixel point is defective.

The feature classification network is a classification network specific to pixel feature points, the feature classification network may be composed of MLP (Multilayer Perceptron), its input is M*N (1, C)-dimensional feature maps generated based on the fused feature map, and its output is M*N (1,)-dimensional classification values, representing the probability that each feature point is normal or abnormal, the M*N (1,) classification values are reorganized into (M, N) classified score maps according to their coordinate positions.

When training the feature classification network, it can be trained based on defect object samples, so that the feature classification network can learn features of defects and the difference between normal features and defect features, so as to obtain the capability to classify normal features and defect features, such that the defect detection model can learn features of defect object samples, which enhances the classification and detection capability of the defect detection model for difficult defect samples such as slight, small defects, and weak textures, compensates for the deficiency of the automatic encoder not supporting defect detection, and improves the overall defect detection capability of defect detection samples. Therefore, when parameter updating is performed on the feature classification network, the parameters of the feature classification network can be frozen where the detection object sample is a normal object sample, that is, when parameter updating is performed on the defect detection model, the parameters of the feature classification network are not updated, and where the detection object sample is a defective object sample, the parameters of the feature classification network are updated.

At step 550, weighted fusing is performed on the defect score map of the detection object sample and the classified score map pixel by pixel obtain a comprehensive defect score map of the detection object sample.

When weighted fusing is performed on the defect score map and the classified score map, the defect score map and the classified score map have their own weight settings, and the sum of the two weights is 1. By way of example, if the weight coefficient of the defect score map is q1, and the weight coefficient of the classified score map is q2, then q1+q2=1, for example, if q1=0.1˜0.2, then q1=0.9˜0.8, so as to control the degree of effect of the classification branch corresponding to the feature classification network and the reconstruction branch corresponding to the feature reconstruction network by setting the weight coefficient; these two weight values can be set based on actual needs, which is not limited in the present disclosure.

Furthermore, after weighted fusing is performed on the defect score map and the classified score map, the fusion result can be normalized to form a normalized defect score map, that is, a comprehensive defect score map; in the comprehensive defect score map, the higher the value corresponding to the pixel point, the higher the possibility that the pixel point is defective.

At step 560, parameters of the defect detection model are updated based on the comprehensive defect score map of the detection object sample, the defect score map of the detection object sample, the classified score map of the detection object sample, and the sample label of the detection object sample.

In this process, the computer equipment may calculate a loss function based on the difference among the defect score map, the classified score map, and the score map corresponding to the sample label of the detection object, so as to update parameters the defect detection model based on a function value of the loss function, and this process can be implemented as follows:

A function value of a first loss function is calculated based on the comprehensive defect score map of the detection object sample and the sample label of the detection object sample.

A function value of a second loss function is calculated based on the defect score map of the detection object sample and the sample label of the detection object sample;

A function value of a third loss function is calculated based on the classified score map of the detection object sample and the sample label of the detection object sample.

And parameters of the defect detection model are updated based on the function value of the first loss function, the function value of the second loss function, and the function value of the third loss function.

Optionally, the first loss function may be a mean absolute error (MAE) loss function, also known as L1 Loss, which is used to calculate the difference between a defect score map of the detection object and a score map indicated by a sample label of the detection object sample; the function value of the first loss function may be expressed as loss_score.

Optionally, the second loss function may be an MSE (Mean Squared Error) loss function, when calculating the loss function, the function value of the second loss function may be calculated based on the difference between the defect score map and the score map indicated by the sample label of the detection object sample; alternatively, further, the function value of the loss function corresponding to the corresponding branches may be obtained based on the weights corresponding to the global defect score map and the weights corresponding to the local defect score map, which are expressed as loss_ae_map and loss_ae_single, respectively, the function value of the second loss function is equal to loss_ae_map+loss_ae_single.

Optionally, the third loss function may be a weighted cross-entropy loss function, referred to as loss_cls; for each defect classification ∈{1, 2, . . . , C}, the softmax function may calculate the probability value of this defect classification by the following equation:

$${\hat{p}}_{i} = \frac{{e}^{{z}_{i}}}{{\sum }_{j = 1}^{c} {e}^{Z} j}$$

E (⋅, ⋅) represent the cross-entropy function, and the output probability distribution is denoted as [\hat{p}₁, \hat{p}₂, . . . , \hat{p}_{C}]^{T},
The weighted cross-entropy classification loss function is:

$$loss\_cls = α E ( \hat{p} , {y}_{r} ) + ( 1 - α ) E ( \hat{p} , {y}_{c} )$$

In embodiments of the present disclosure, when updating parameters of each network in the defect detection model, it is necessary to update the sample type, where the detection object sample is a normal object sample, there are no defective pixels and defect features, at this time, the feature classification network is frozen and corresponding parameters are not trained, at this time, the third loss function is set to 0, that is, loss_cls=0, and the loss function is calculated, that is:

where the detection object sample is a normal object sample, a total loss function value is calculated based on the function value of the first loss function and the function value of the second loss function, and parameters of the feature reconstruction network are updated in the defect detection model based on the total loss function value.

When updating parameters of the feature reconstruction network in the defect detection model, parameters of the feature extraction network may not be updated, alternatively, the parameters of the feature extraction network may be fine-tuned.

Where the detection object sample is a defective object sample, there are defective pixels and defective features, at the same time, after the defect fusion features corresponding to defective areas in the fused feature map of the defective object sample are masked, the feature reconstruction network can learn feature information of normal images, therefore, during training of the model, where the detection object sample is a defective object sample, a total loss function value is calculated based on the function value of the first loss function, the function value of the second loss function and the function value of the third loss function, and parameter updating is performed on the feature reconstruction network and the feature classification network in the defect detection model based on the total loss function value.

By way of example, the total loss function may be denoted as:

$$loss\_final = q 2 * ( loss\_ae \_map + loss\_ae \_single ) + q 1 * loss\_cls + loss\_score$$

Wherein loss_cls=0, q1 is the weight coefficient corresponding to the feature classification branch, q2 is the weight coefficient corresponding to the feature reconstruction network, q1+q2=1; where the detected object sample is a normal object sample, loss_cls=0.

Wherein the trained defect detection model is used for performing defect detection on a to-be-detected object based on the RGB image and the depth image of the to-be-detected object.

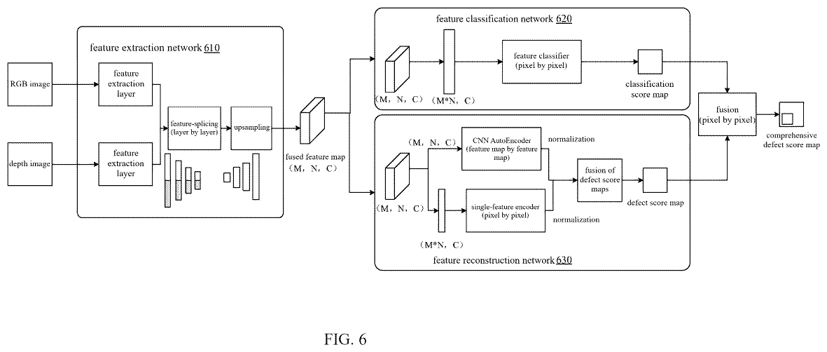

FIG. 6 illustrates a structural schematic diagram of a defect detection model provided in an exemplary embodiment of the present disclosure, As shown in FIG. 6, the defect detection model includes a feature extraction network 610, a feature classification network 620, and a feature reconstruction network 630; after an RGB image and a depth image of the to-be-detected object are input into the defect detection model, the feature extraction layer corresponding to the RGB image in the feature extraction network 610 extracts a RGB feature map, and the feature extraction layer corresponding to the depth image extracts a depth feature map; the RGB feature map and the depth feature map are subjected to feature-splicing, upsampling, and channel merging layer by layer through the feature fusion layer in the feature extraction network 610, so as to obtain a fused feature map; the fused feature map is input into the feature classification network 620 and the feature reconstruction network 630; by performing feature classification pixel by pixel in the feature classification network 620, a classified score map indicating the probability that each pixel point is defective can be obtained; in the feature reconstruction network 630, defect detection is performed by an image-level autoencoder by the global defect detection network based on a global perspective to obtain a global defect score map, and defect detection is performed by a pixel-level autoencoder by the local defect detection network based on a local perspective to obtain a local defect score map, and the global defect score map and the local defect score map are fused to obtain a defect score map; thereafter, the defect score map and the classified score map are fused pixel by pixel to obtain a comprehensive defect score map; based on the scores of each pixel point in the comprehensive defect score map, it is determined whether the to-be-detected object has defects, as shown in FIG. 6, when it is determined that the to-be-detected object has defects, the defect area can be determined based on the comprehensive defect score map.

In summary, according to the defect detection method provided in embodiments of the present disclosure, when a defect detection model is trained, feature map extraction and feature map fusion are performed based on an RGB image and a depth image of a detection object sample to obtain a fused feature map, then a global defect score map and a local defect score map are generated based on the fused feature map respectively by a global defect detection network in a feature reconstruction network from a global perspective and a local defect detection network in the feature reconstruction network from a local perspective and, so as to fuse the two defect score maps to obtain a defect score map, then defect detection is performed on the defect detection model based on the defect score map and a sample label of the detection object sample; by means of the above-mentioned method, the defect detection model can learn global anomaly detection capability and local anomaly detection capability during the model training process, such that when the defect detection model is applied to defect detection, defect detection can be performed from both global perspective and local perspective, thereby improving the comprehensiveness and accuracy of defect detection.

In addition, by adding a feature classification network to the defect detection model, the defect detection model can obtain the capability to learn defect features of defective samples, which enhances the classification and detection capability of the defect detection model for difficult defect samples such as slight, small defects, and weak textures, compensates for the deficiency of the automatic encoder not supporting defect detection, and further improves the overall defect detection capability of defect detection samples, thereby further improving the comprehensiveness and accuracy of defect detection.

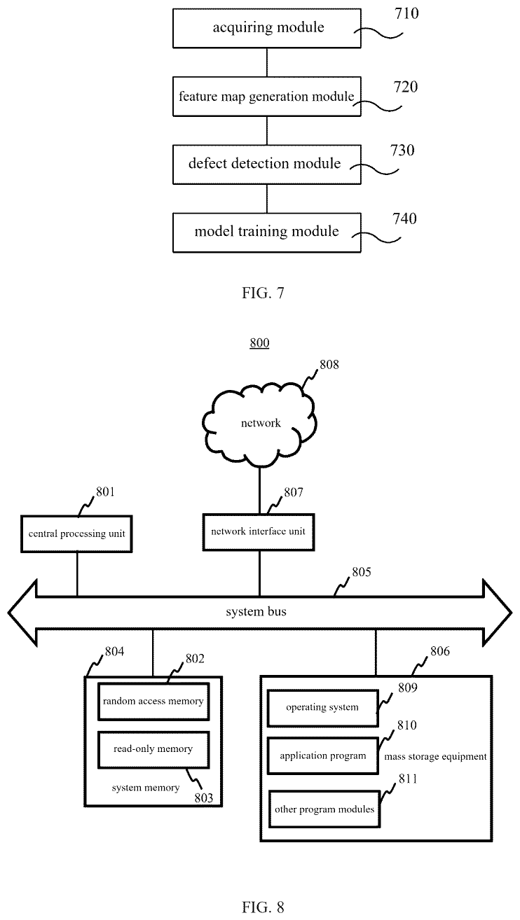

FIG. 7 illustrates a block diagram of a defect detection device provided in an exemplary embodiment of the present disclosure; the device can perform all or part of steps of embodiments shown in FIG. 1, FIG. 2 or FIG. 5, as shown in FIG. 7.

The device includes an acquiring module 710, configured to acquire an RGB image of a detection object sample, a depth image of a detection object sample, and a sample label of the detection object sample; a feature map generation module 720, configured to perform feature map extraction and feature map fusion on the RGB image and the depth image of the detection object sample by means of a feature extraction network of the defect detection model, so as to obtain a fused feature map; a defect detection module 730, configured to perform defect detection based on the fused feature map by means of a feature reconstruction network of the defect detection model, so as to obtain a defect score map of the detection object sample, wherein the feature reconstruction network comprises a global defect detection network and a local defect detection network, the global defect detection network is used to generate a global defect score map based on the fused feature map from a global perspective, the local defect detection network is used to generate a local defect score map based on the fused feature map from a local perspective, and the defect score map is obtained by fusing the global defect score map with the local defect score map; and a model training module 740 configured to update parameters of the defect detection model based on the defect score map of the detection object sample and the sample label of the detection object sample. Where a trained defect detection model is used for performing defect detection on a to-be-detected object according to an RGB image and a depth image of a to-be-detected object.

In one possible implementation, the detection object sample is a normal object sample or a defective object sample; upon the condition that the detection object sample is a defective object sample, the sample label of the detection object sample includes a defect area annotation; and the defect detection module includes 730: a mask-processing submodule for masking a defect fusion feature in the fused feature map based on the defect area annotation; and a defect detection submodule for performing defect detection based on a masked fused feature map by a feature reconstruction network of the defect detection model, so as to obtain a defect score map of the detection object sample.

In one possible implementation, the defect detection module 730 includes: a first processing submodule for performing compression, decompression, and calculation of anomaly score on the fused feature map by the global defect detection network, so as to obtain the global defect score map; a second processing submodule for performing compression, decompression, and calculation of anomaly score on the fused feature map by the local defect detection network, so as to obtain defect scores corresponding to pixel features; a reorganizing submodule for reorganizing defect scores corresponding to the pixel features based on position coordinates corresponding to the pixel features, so as to obtain the local defect score map; and a first fusion submodule for fusing the global defect score map with the local defect score map, so as to obtain the defect score map of the detection object sample.

In one possible implementation, the first fusion submodule includes: a normalization unit for normalizing the global defect score map and the local defect score map pixel by pixel respectively so as to obtain a normalized global defect score map and a normalized local defect score map; and a fusion unit for performing weighted fusing on the normalized global defect score map and the normalized local defect score map, so as to obtain the defect score map of the detection object sample.

In one possible implementation, the model training module 740 is used to: upon the condition that the detection object sample is a normal object sample, update parameters of the defect detection model based on an image type indicated by the defect score map of the detection object sample and an image type indicated by the sample label of the detection object sample; or upon the condition that the detection object sample is a defective object sample, update parameters of the defect detection model based on a predicted defect area indicated by the defect score map of the detection object sample and a defect area indicated by the sample label of the detection object sample.

In one possible implementation, the defect detection module includes a feature classification network; and the device further includes a feature classification module for performing feature classification based on the fused feature map of the detection object sample by the feature classification network in the defect detection model, so as to obtain a classified score map of the detection object sample; each score in the classified score map is used to indicate the probability that a corresponding pixel point is defective. The model training module 740 includes: a second fusion submodule for performing weighted fusing on a defect score map of the detection object sample and the classified score map pixel by pixel respectively, so as to obtain a comprehensive defect score map of the detection object sample; and a parameter updating submodule for updating parameters of the defect detection model based on the comprehensive defect score map of the detection object sample, the defect score map of the detection object sample, the classified score map of the detection object sample, and the sample label of the detection object sample.

In one possible implementation, the parameter updating submodule includes: a first calculation unit for calculating a function value of a first loss function based on the comprehensive defect score map of the detection object sample and a sample label of the detection object sample; a second calculation unit for calculating a function value of a second loss function based on the defect score map of the detection object sample and the sample label of the detection object sample; a third calculation unit for calculating a function value of a third loss function based on the classified score map of the detection object sample and a sample label of the detection object sample; and a parameter updating unit for updating parameters of the defect detection model based on the function value of the first loss function, the function value of the second loss function, and the function value of the third loss function.

In one possible implementation, the parameter updating unit is used to: upon the condition that the detection object sample is a normal object sample, calculate a total loss function value based on the function value of the first loss function and the function value of the second loss function, and update parameters of the feature reconstruction network in the defect detection model based on the total loss function value; or, upon the condition that the detection object sample is a defective object sample, calculate a total loss function value based on the function value of the first loss function, the function value of the second loss function and the function value of the third loss function, and update parameters of the feature reconstruction network and the feature classification network in the defect detection model based on the total loss function value.

In one possible implementation, the feature extraction network includes a first feature extraction layer, a second feature extraction layer and a feature fusion layer. The feature map generation module 720 includes: a first extraction submodule for performing feature map extraction on the RGB image of the detection object sample by the first feature extraction layer, so as to obtain a corresponding RGB feature map; a second extraction submodule for performing feature map extraction on a depth image of the detection object sample by the second feature extraction layer, so as to obtain a corresponding depth feature map; and a feature fusion submodule for performing feature fusion on the RGB feature map and the depth feature map by the feature fusion layer, so as to obtain the fused feature map.

In conclusion, according to the defect detection device provided in embodiments of the present disclosure, when a defect detection model is trained, feature map extraction and feature map fusion are performed based on an RGB image and a depth image of a detection object sample to obtain a fused feature map, then a global defect score map and a local defect score map are generated based on the fused feature map respectively by a global defect detection network in a feature reconstruction network from a global perspective and a local defect detection network in the feature reconstruction network from a local perspective and, so as to fuse the two defect score maps to obtain a defect score map, then defect detection is performed on the defect detection model based on the defect score map and a sample label of the detection object sample; by means of the above-mentioned device, the defect detection model can learn global anomaly detection capability and local anomaly detection capability during the model training process, such that when the defect detection model is applied to defect detection, defect detection can be performed from both global perspective and local perspective, thereby improving the comprehensiveness and accuracy of defect detection.

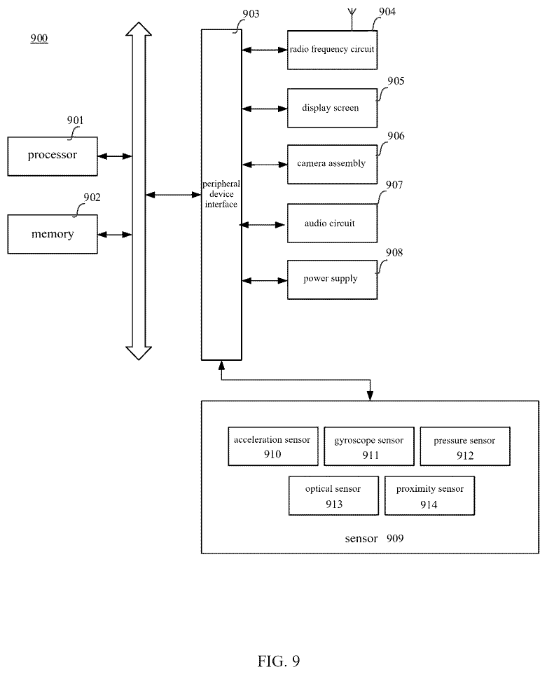

FIG. 8 is a structural block diagram of a computer equipment 800 provided in an exemplary embodiment of the present disclosure. The computer equipment can be implemented as a server in the above-mentioned implementations of the present disclosure. The computer equipment 800 includes a central processing unit (CPU) 801, a system memory 804 that includes a random access memory (RAM) 802 and a read-only memory (ROM) 803, and a system bus 805 that connects the system memory 804 and the central processing unit 801. The computer equipment 800 further includes a mass storage equipment 806 for storing an operating system 809, an application program 810 and other program modules 811.

Without loss of generality, the computer-readable medium may include computer storage media and communication media. Computer storage media includes volatile and nonvolatile, removable and non-removable media implemented in any method or technology for storage of information such as computer readable instructions, data structures, program modules, or other data. Computer storage media include RAM, ROM, Erasable Programmable Read Only Memory (EPROM), Electronically-Erasable Programmable Read-Only Memory (EEPROM) flash memory or other solid-state storage technology, CD-ROM, Digital Versatile Disc (DVD) or other optical storage, tape cassettes, tapes, disk storage or other magnetic storage devices. Of course, the skilled person will know that the computer storage medium is not limited to the above-mentioned types. The above-mentioned system memory 804 and mass storage equipment 806 may be collectively referred to as memory.

According to various embodiments of the present disclosure, the computer equipment 800 may also operate as a remote computer connected to a network via a network, such as the Internet. That is, the computer equipment 800 can be connected to the network 808 through the network interface unit 807 connected to the system bus 805, or the network interface unit 807 can be used to connect to other types of networks or remote computer systems (not shown).

The memory further includes at least one instruction, at least one program, code set or instruction set, and the at least one instruction, at least one program, code set or instruction set are stored in the memory, the central processing unit 801 implements all or part of the steps in the defect detection method shown in the above-mentioned embodiments by executing the at least one instruction, at least one program, code set or instruction set.

FIG. 9 is a structural block diagram of a computer equipment 900 provided in an exemplary embodiment of the present disclosure. The computer equipment 900 may be implemented as the above-mentioned terminal, such as a smart phone, a tablet computer, a laptop computer, a desktop computer, etc. The computer equipment 900 may also be known as a user device, a portable terminal, a laptop terminal, a desktop terminal, etc.

Generally, the computer equipment 900 includes a processor 901 and a memory 902.

In some embodiments, the computer equipment 900 may also optionally include: a peripheral device interface 903 and at least one peripheral device. The processor 901, the memory 902 and the peripheral device interface 903 may be connected via a bus or a signal line. Each peripheral device may be connected to the peripheral device interface 903 via a bus, a signal line or a circuit board. Specifically, the peripheral device includes at least one of a radio frequency circuit 904, a display screen 905, a camera assembly 906, an audio circuit 907 and a power supply 908.

In some embodiments, the computer equipment 900 further includes one or more sensors 909. The one or more sensors 909 include but not limited to an acceleration sensor 910, a gyroscope sensor 911, a pressure sensor 912, an optical sensor 913, and a proximity sensor 914.

The skilled person can understand that, the hardware structure as shown in FIG. 9 does not constitute a limitation on the computer equipment 900, and the inter-cell interference coordination device can comprise more or less components than those illustrated, a combination of certain components, or different arrangement of components.

In one exemplary embodiment, there is provided a non-transitory computer-readable storage medium, the computer-readable storage medium stores at least one computer program, and the computer program is loaded and executed by a processor to implement all or part of the steps in the above-mentioned feature extraction model training method and/or the defect detection method. For example, the computer-readable storage medium may be a read-only memory (ROM), a random access memory (RAM), a compact disc read-only memory (CD-ROM), a magnetic tape, a floppy disk, an optical data storage device, etc.

In one exemplary embodiment, there is further provided a computer program product, which includes a computer program stored on a non-transitory computer-readable storage medium, and the computer program includes program instructions, the program instructions, when executed by a computer, makes the computer implement all or part of the steps of the defect detection method shown in FIG. 1, FIG. 2 or FIG. 4 above.

Those skilled in the art will readily appreciate other solutions of the present disclosure after considering the description and practicing the disclosure disclosed herein. The present disclosure is intended to cover any variations, uses or adaptations of the present disclosure, which follow the general principles of the present disclosure and include common knowledge or customary technical means in the art that are not disclosed in the present disclosure. The description and embodiments are to be considered as exemplary only, and the true scope and spirit of the present disclosure are indicated by the following claims.

It should be understood that the present disclosure is not limited to the precise structures that are described above and shown in the drawings, and various modifications and changes may be made without departing from the scope thereof. The scope of the present disclosure is limited only by the appended claims.

What is claimed is:

1. A defect detection method, comprising:
acquiring an RGB image of a detection object sample, a depth image of the detection object sample, and a sample label of the detection object sample;
performing, by a feature extraction network of a defect detection model, feature map extraction and feature map fusion on the RGB image and the depth image of the detection object sample, so as to obtain a fused feature map;
performing, by a feature reconstruction network of the defect detection model, defect detection based on the fused feature map, so as to obtain a defect score map of the detection object sample; wherein the feature reconstruction network comprises a global defect detection network and a local defect detection network, the global defect detection network is used to generate a global defect score map based on the fused feature map from a global perspective, and the local defect detection network is used to generate a local defect score map based on the fused feature map from a local perspective; and the defect score map is obtained by fusing the global defect score map with the local defect score map; and
updating, based on the defect score map of the detection object sample and the sample label of the detection object sample, parameters of the defect detection model;
wherein a trained defect detection model is used for performing defect detection on a to-be-detected object according to an RGB image and a depth image of the to-be-detected object.

2. The method according to claim 1, wherein the detection object sample is a normal object sample or a defective object sample;
upon a condition that the detection object sample is a defective object sample, the sample label of the detection object sample comprises a defect area annotation; and
performing, by the feature reconstruction network of the defect detection model, defect detection based on the fused feature map, so as to obtain the defect score map of the detection object sample comprises:
masking, based on the defect area annotation, a defect fusion feature in the fused feature map; and
performing, by the feature reconstruction network of the defect detection model, defect detection based on a masked fused feature map, so as to obtain the defect score map of the detection object sample.

3. The method according to claim 1, wherein performing, by the feature reconstruction network of the defect detection model, defect detection based on the fused feature map, so as to obtain the defect score map of the detection object sample comprises:
performing, by the global defect detection network, compression, decompression, and calculation of anomaly score on the fused feature map, so as to obtain the global defect score map;
performing, by the local defect detection network, compression, decompression, and calculation of anomaly score on the fused feature map, so as to obtain defect scores corresponding to pixel features;
reorganizing, based on position coordinates corresponding to the pixel features, the defect scores corresponding to the pixel features, so as to obtain the local defect score map; and
fusing the global defect score map with the local defect score map, so as to obtain the defect score map of the detection object sample.

4. The method according to claim 2, wherein performing, by the feature reconstruction network of the defect detection model, defect detection based on the fused feature map, so as to obtain the defect score map of the detection object sample comprises:
performing, by the global defect detection network, compression, decompression, and calculation of anomaly score on the fused feature map, so as to obtain the global defect score map;
performing, by the local defect detection network, compression, decompression, and calculation of anomaly score on the fused feature map, so as to obtain defect scores corresponding to pixel features;
reorganizing, based on position coordinates corresponding to the pixel features, the defect scores corresponding to the pixel features, so as to obtain the local defect score map; and
fusing the global defect score map with the local defect score map, so as to obtain the defect score map of the detection object sample.

5. The method according to claim 3, wherein fusing the global defect score map with the local defect score map, so as to obtain the defect score map of the detection object sample comprises:
normalizing the global defect score map and the local defect score map pixel by pixel respectively, so as to obtain a normalized global defect score map and a normalized local defect score map; and
performing weighted fusing on the normalized global defect score map and the normalized local defect score map, so as to obtain the defect score map of the detection object sample.

6. The method according to claim 4, wherein fusing the global defect score map with the local defect score map, so as to obtain the defect score map of the detection object sample comprises:
normalizing the global defect score map and the local defect score map pixel by pixel respectively, so as to obtain a normalized global defect score map and a normalized local defect score map; and
performing weighted fusing on the normalized global defect score map and the normalized local defect score map, so as to obtain the defect score map of the detection object sample.

7. The method according to claim 2, wherein updating, based on the defect score map of the detection object sample and the sample label of the detection object sample, parameters of the defect detection model comprises:
upon the condition that the detection object sample is a normal object sample, updating, based on an image type indicated by the defect score map of the detection object sample and an image type indicated by the sample label of the detection object sample, parameters of the defect detection model.

8. The method according to claim 2, wherein updating, based on the defect score map of the detection object sample and the sample label of the detection object sample, parameters of the defect detection model comprises:
upon the condition that the detection object sample is a defective object sample, updating, based on a predicted defect area indicated by the defect score map of the detection object sample and a defect area indicated by the sample label of the detection object sample, parameters of the defect detection model.

9. The method according to claim 2, wherein the defect detection model further comprises a feature classification network; and the method further comprises:
performing, by the feature classification network of the defect detection model, feature classification based on the fused feature map of the detection object sample, so as to obtain a classified score map of the detection object sample; wherein each score in the classified score map is used to indicate a probability that a corresponding pixel point is defective; and
updating, based on the defect score map of the detection object sample and the sample label of the detection object sample, parameters of the defect detection model comprises:
performing weighted fusing on the defect score map of the detection object sample and the classified score map pixel by pixel respectively, so as to obtain a comprehensive defect score map of the detection object sample; and
updating, based on the comprehensive defect score map of the detection object sample, the defect score map of the detection object sample, the classified score map of the detection object sample and the sample label of the detection object sample, parameters of the defect detection model.

10. The method according to claim 9, wherein updating, based on the comprehensive defect score map of the detection object sample, the defect score map of the detection object sample, the classified score map of the detection object sample and the sample label of the detection object sample, parameters of the defect detection model comprises:
calculating, based on the comprehensive defect score map of the detection object sample and the sample label of the detection object sample, a function value of a first loss function;
calculating, based on the defect score map of the detection object sample and the sample label of the detection object sample, a function value of a second loss function;
calculating, based on the classified score map of the detection object sample and the sample label of the detection object sample, a function value of a third loss function; and
updating, based on the function value of the first loss function, the function value of the second loss function, and the function value of the third loss function, parameters of the defect detection model.

11. The method according to claim 10, wherein updating, based on the function value of the first loss function, the function value of the second loss function, and the function value of the third loss function, parameters of the defect detection model comprises:
upon the condition that the detection object sample is a normal object sample, calculating, based on the function value of the first loss function and the function value of the second loss function, a total loss function value, and updating, based on the total loss function value, parameters of the feature reconstruction network of the defect detection model.

12. The method according to claim 10, wherein updating, based on the function value of the first loss function, the function value of the second loss function, and the function value of the third loss function, parameters of the defect detection model comprises:
upon the condition that the detection object sample is a defective object sample, calculating, based on the function value of the first loss function, the function value of the second loss function and the function value of the third loss function, a total loss function value, and updating, based on the total loss function value, parameters of both the feature reconstruction network and the feature classification network of the defect detection model.

13. The method according to claim 1, wherein the feature extraction network comprises a first feature extraction layer, a second feature extraction layer and a feature fusion layer; and
performing, by the feature extraction network of the defect detection model, feature map extraction and feature map fusion on the RGB image and the depth image of the detection object sample, so as to obtain the fused feature map comprises:
performing, by the first feature extraction layer, feature map extraction on the RGB image of the detection object sample, so as to obtain a corresponding RGB feature map;
performing, by the second feature extraction layer, feature map extraction on the depth image of the detection object sample, so as to obtain a corresponding depth feature map; and
performing, by the feature fusion layer, feature fusion on the RGB feature map and the depth feature map, so as to obtain the fused feature map.

14. A defect detection device, comprising:
an acquiring module, configured to acquire an RGB image of a detection object sample, a depth image of a detection object sample, and a sample label of the detection object sample;
a feature map generation module, configured to perform feature map extraction and feature map fusion on the RGB image and the depth image of the detection object sample by means of a feature extraction network of the defect detection model, so as to obtain a fused feature map;
a defect detection module, configured to perform defect detection based on the fused feature map by means of a feature reconstruction network of the defect detection model, so as to obtain a defect score map of the detection object sample; wherein the feature reconstruction network comprises a global defect detection network and a local defect detection network, the global defect detection network is used to generate a global defect score map based on the fused feature map from a global perspective, and the local defect detection network is used to generate a local defect score map based on the fused feature map from a local perspective; and the defect score map is obtained by fusing the global defect score map with the local defect score map; and
a model training module configured to update parameters of the defect detection model based on the defect score map of the detection object sample and the sample label of the detection object sample;
wherein a trained defect detection model is used for performing defect detection on a to-be-detected object according to an RGB image and a depth image of a to-be-detected object.

15. A computer equipment, wherein the computer equipment comprises a processor and a memory, the memory stores at least one computer program, and the at least one computer program is loaded and executed by the processor to implement the defect detection method according to claim 1.

16. A non-transitory computer-readable storage medium, wherein the computer-readable storage medium stores at least one computer program, and the computer program is loaded and executed by a processor to implement the defect detection method according to claim 1.
